(19) United States
(12) Patent Application Publication
(10) Pub. No.: US 2026/0144283 A1
(43) Pub. Date: May 28, 2026

(54) DRINKABLE ELECTROLYTE SOLUTIONS

(71) Applicant: Kenvue Brands LLC, Summit, NJ (US)

(72) Inventors: Katherine C. Dectis, Langhorne, PA (US); Patricia L. Golas, Somerville, NJ (US); Amanda Nicole Rogers, American Fork, UT (US); Nancy Edge, Summit, NJ (US)

(21) Appl. No.: 19/339,845

(22) Filed: Sep. 25, 2025

Related U.S. Application Data
(60) Provisional application No. 63/699,362, filed on Sep. 26, 2024.

(51) Int. Cl. A23L 33/16; A23L 2/38; A23L 2/60

(52) U.S. Cl. CPC A23L 33/16; A23L 2/38; A23L 2/60

(57) ABSTRACT

Drinkable solutions comprising one or more electrolytes and processes of manufacturing the same. Such solutions can be used in the rehydration of a human in need thereof.

### CROSS-REFERENCE TO RELATED APPLICATIONS

This application claims the benefit of U.S. provisional application 63/699,362 filed on Sep. 26, 2024, the complete disclosure of which is hereby incorporated herein by reference for all purposes.

### 1. FIELD

The present disclosure generally relates to drinkable solutions, and in particular to a ready to drink solution comprising one or more electrolytes. The disclosure further relates to methods of manufacturing such drinkable solutions and to the use of such drinkable solutions for the rehydration of a human.

### 2. BACKGROUND

Dehydration is a health concern that affects individuals of all ages, particularly children and athletes. Various factors can contribute to dehydration including intense physical activity, inadequate fluid intake, hot weather, and illness. Standard beverages such as water often lack the necessary electrolytes to effectively rehydrate and restore balance within the body.

Electrolyte drinks are typically formulated to replace the body's essential minerals such as sodium, potassium, chloride, magnesium, and calcium. However, many existing products contain high levels of sugars, which may not be suitable for all consumers, especially children. Despite the availability of electrolyte drinks, there remains a need for innovative formulations that prioritize health and wellness while being effective and palatable to the consumer. Effective hydration with a focus on natural ingredients, balanced electrolyte ratios, and appealing flavors are desirable in such product forms. The present disclosure addresses these and other needs.

### 3. SUMMARY

The present disclosure provides drinkable solutions. The drinkable solution includes one or more electrolytes, one or more prebiotics, one or more trace minerals, and one or more rehydration sugars.

In certain embodiments, the one or more prebiotics can include gum acacia.

In certain embodiments, the one or more rehydration sugars can include dextrose monohydrate.

In certain embodiments, the one or more electrolytes can include sodium, potassium, and chloride.

In certain embodiments, the one or more trace minerals can include zinc. In certain embodiments, the drinkable solution can further include one or more preservatives.

In certain embodiments, the drinkable solution can further include one or more sweeteners. The one or more sweeteners can include Rebaudioside M (RebM), monk fruit (juice concentrate), or combinations thereof.

In certain embodiments, the one or more prebiotics can be present in an amount of about 0.01% to about 5% by weight, based on the total weight of the drinkable solution. In certain embodiments, the one or more electrolytes can be present in an amount of at least about 0.01% by weight, based on the total weight of the drinkable solution.

The present disclosure provides drinkable solutions for the rehydration of a human. The drinkable solution can include one or more electrolytes including sodium, potassium, and chloride; one or more sweeteners comprising Rebaudioside M (RebM); one or more trace minerals; and one or more prebiotics.

In certain embodiments, the one or more electrolytes can be present in an amount of from about 0.01% to about 5% by weight, based on the total weight of the drinkable solution.

In certain embodiments, the one or more prebiotics can include gum acacia.

In certain embodiments, the one or more trace minerals can include zinc.

In certain embodiments, the one or more sweeteners can further include monk fruit.

In certain embodiments, the drinkable solution can further include one or more rehydration sugars. The one or more rehydration sugars can include dextrose monohydrate.

In certain embodiments, the drinkable solution can be substantially free of preservatives.

The present disclosure further provides for methods of rehydration of a human. Such methods include administering the drinkable solutions of the present disclosure to the human.

### 4. DETAILED DESCRIPTION

The presently disclosed subject matter relates to drinkable solutions, and in particular ready to drink solutions, including one or more electrolytes and methods of manufacturing the same. Such solutions can be used for the rehydration of a human in need thereof.

These and other aspects of the disclosed subject matter are discussed in more detail below and in the Examples. For clarity, and not by way of limitation, this detailed description is divided into the following sub-portions:
4.1. Definitions;
4.2. Drinkable Solutions;
4.3. Methods of Making Drinkable Solutions;
4.4. Methods of Using Drinkable Solutions; and
4.5. Features of Drinkable Solutions.

### 4.1. Definitions

The terms used in this specification generally have their ordinary meanings in the art within the context of this disclosure and in specific context where each term is used. Certain terms are discussed below, or elsewhere in the specification, to provide additional guidance in describing the compositions and methods of the disclosure and how to make and use them.

As used in the specification and the appended claims, the singular forms “a,” “an,” and “the” include the plural referents unless the context clearly dictates otherwise. Thus, for example, reference to “an ingredient” includes mixtures of ingredients.

To provide a more concise description, some of the quantitative expressions given herein are not qualified with the term “about”. It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value. The general convention in the scientific and technical literature is applied: the last decimal place of a numerical value indicates its degree of accuracy. Where no other error margins are given, the maximum margin is ascertained by applying the rounding-off convention to the last decimal place, for example for a measurement of 3.5%, the error margin is 3.45-3.54.

As used herein, “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

The expression “one or more” is synonymous with “at least one” and includes individual components as well as mixtures/combinations.

All percentages, parts and ratios herein are based upon the total weight of the cleaning compositions of the present disclosure, unless otherwise indicated.

As used herein, the terms “% w/w” or “weight percent” refers to the percentage of an ingredient(s)/the total percentage by weight of the composition (100%). The terms “% w/w” or “weight percent” refer to the quantity by weight of a constituent or component. The terms “weight percent”, “wt-%”, “wt. %”, and “wt %” are used interchangeably.

All publications and patent applications cited in this specification are herein incorporated by reference, and for any and all purposes, as if each individual publication or patent application were specifically and individually indicated to be incorporated by reference. The present disclosure controls if there an inconsistency between the present disclosure and any incorporated publications or patents.

### 4.2. Drinkable Solutions

Drinkable solutions of the present disclosure include one or more electrolytes. In certain embodiments, the drinkable solutions can include one or more electrolytes, one or more trace minerals, one or more prebiotics, one or more sweeteners, one or more rehydration sugars, one or more preservatives, one or more acidulants, one or more flavoring agents, one or more diluents, or combinations thereof. In certain embodiments, drinkable solutions of the present disclosure can include one or more electrolytes, one or more trace minerals, one or more prebiotics, one or more sweeteners, one or more rehydration sugars, one or more acidulants, and or more flavoring agents, one or more diluents, or combinations thereof.

### 4.2.1. Electrolytes

The drinkable solution can include one or more electrolytes. A person skilled in the art will appreciate a wide variety of electrolytes can be suitable for use with the present disclosure. In certain embodiments, the one or more electrolytes can include sodium, potassium, chloride, or combinations thereof. For example, and not by way of limitation, the one or more electrolytes can include sodium (as sodium chloride), chloride (as sodium chloride), potassium (as tripotassium citrate), or combinations thereof. In particular embodiments, the one or more electrolytes can include sodium, potassium, and chloride as sodium (as sodium chloride), chloride (as sodium chloride), potassium (as tripotassium citrate).

The one or more electrolytes can be present in an amount of from about 0.01% to about 5%, about 0.1% to about 2%, or about 0.2% to about 8% by weight, based on total weight of the drinkable solution. In certain embodiments, the one or more electrolytes can be present in an amount of about 0.2%, about 0.3%, about 0.4%, about 0.5%, about 1%, about 2%, or about 3% by weight, based on the total weight of the drinkable solution. In particular embodiments, the one or more electrolytes can be present in an amount of at least about 0.01%, at least about 0.1%, at least about 0.2%, at least about 0.3% or at least about 0.4% by weight, based on the total weight of the drinkable solution.

### 4.2.2. Trace Minerals

The drinkable solution can include one or more trace minerals. A person skilled in the art will appreciate a wide variety of trace minerals can be suitable for use with the present disclosure. In certain embodiments, the one or more trace minerals can include zinc, for example, as zinc gluconate.

The one or more trace minerals can be present in an amount of from about 0.001% to about 1%, about 0.005% to about 0.5%, or about 0.006% to about 0.1% by weight, based on the total weight of the drinkable solution. In certain embodiments, the one or more trace minerals can be present in an amount of about 0.001%, about 0.005%, about 0.007%, about 0.01%, about 0.1%, about 0.5%, or about 1% by weight, based on the total weight of the drinkable solution. In particular embodiments, the one or more trace minerals can be present in an amount of at least about 0.001%, at least about 0.005%, at least about 0.007%, at least about 0.01%, at least about 0.1%, or at least about 0.5% by weight, based on the total weight of the drinkable solution.

The drinkable solution can include one or more prebiotics. A person skilled in the art will appreciate a wide variety of prebiotics can be suitable for use with the present disclosure. In certain embodiments, the one or more prebiotics can include a dietary fiber such as gum acacia.

The one or more prebiotics can be present in an amount of about 0.01% to about 5%, about 0.1% to about 3%, or about 0.5% to about 1% by weight, based on the total weight of the drinkable solution. In certain embodiments, the one or more prebiotics can be present in an amount of about 0.01%, about 0.1%, about 0.5%, about 0.9%, about 1%, about 3%, or about 5% by weight, based on the total weight of the drinkable solution. In particular embodiments, the one or more prebiotics can be present in an amount of at least about 0.01%, at least about 0.1%, at least about 0.5%, at least about 0.9%, at least about 1%, or at least about 3% by weight, based on the total weight of the drinkable solution.

### 4.2.4. Sweeteners

The drinkable solution can include one or more sweeteners. A person skilled in the art will appreciate a wide variety of sweeteners can be suitable for use with the present disclosure. In certain embodiments, the one or more sweeteners can include Rebaudioside M (RebM), monk fruit (juice concentrate), or combinations thereof. In particular embodiments, the one or more sweeteners can include Rebaudioside M (RebM) and monk fruit (juice concentrate).

The one or more sweeteners can be present in an amount of from about 0.01% to about 5%, about 0.1% to about 1%, or about 0.3% to about 0.9% by weight, based on the total weight of the drinkable solution. In certain embodiments, the one or more sweeteners can be present an amount of about 0.01%, about 0.1%, about 0.4%, about 0.5%, about 1%, or about 3% by weight, based on the total weight of the drinkable solution. In particular embodiments, the one or more sweeteners can be present in an amount of at least about 0.01%, at least about 0.1%, at least about 0.4%, at least about 0.5%, or at least 1% by weight, based on the total weight of the drinkable solution.

### 4.2.5. Rehydration Sugars

The drinkable solution can include one or more rehydration sugars. A person skilled in the art will appreciate a wide variety of rehydration sugars can be suitable for use with the present disclosure. In certain embodiments, the one or more rehydration sugars can include dextrose monohydrate. In particular embodiments, the one or more rehydration sugars is dextrose monohydrate.

The one or more rehydration sugars can be present in an amount of from about 1% to about 8%, about 1.2% to about 6%, or about 1.5% to about 3% by weight, based on the total weight of the drinkable solution. In certain embodiments, the one or more rehydration sugars can be present in an amount of about 1%, about 1.2%, about 1.5%, about 3%, or about 4% by weight, based on the total weight of the drinkable solution. In particular embodiments, the one or more rehydration sugars can be present in an amount of at least about 1%, at least about 1.2%, at least about 1.5%, at least about 3%, or at least about 5% by weight, based on the total weight of the drinkable solution.

### 4.2.6. Preservatives

The drinkable solution can include one or more preservatives. A person skilled in the art will appreciate a wide variety of preservatives can be suitable for use with the present disclosure. In certain embodiments, the one or more preservatives can include benzoic acid, potassium sorbate, or combinations thereof. In particular embodiments, the one or more preservatives can include benzoic acid and potassium sorbate.

The one or more preservatives can be present in an amount of from about 0.01% to about 3%, about 0.01% to about 2%, or about 0.02% to about 0.05% by weight, based on total weight of the drinkable solution. In certain embodiments, the one or more preservatives can be present in an amount of about 0.02%, about 0.05%, or about 0.1% by weight, based on the total weight of the drinkable solution. In particular embodiments, the one or more preservatives can be present in an amount of at least about 0.02%, at least about 0.05%, or at least about 0.1% by weight, based on the total weight of the drinkable solution.

In certain embodiments, the drinkable solution can be substantially free of preservatives. The term “substantially free of preservatives” means that the drinkable solution contains less than 0.1% of preservatives, more desirably less than 0.01% of preservatives. In particular embodiments, the drinkable solution does not contain and is free of preservatives. In certain embodiments, the one or more acidulants can include citric acid, for example, citric acid Q.S. to a pH of 3.7-4.0. In particular embodiments, the one or more acidulants is citric acid.

The one or more acidulants can be present in an amount of from about 0.01% to about 2%, about 0.05% to about 1%, or about 0.1% to about 0.75% by weight, based on the total weight of the drinkable solution. In certain embodiments, the one or more acidulants can be present in an amount of about 0.01%, about 0.1%, about 0.75%, about 1.5%, about 1%, or about 2% by weight, based on the total weight of the drinkable solution. In particular embodiments, the one or more acidulants can be present in an amount of at least about 0.01%, at least about 0.1%, at least about 0.75%, at least about 1%, or at least about 1.5% by weight, based on the total weight of the drinkable solution.

### 4.2.8. Flavoring Agents

The drinkable solution can include one or more flavoring agents. A person skilled in the art will appreciate a wide variety of flavoring agents can be suitable for use with the present disclosure. In certain embodiments, the one or more flavoring agents can include a lemon lime flavoring or a strawberry lemonade flavoring.

The one or more flavoring agents can be present in an amount of from about 0.001% to about 0.5%, about 0.08% to about 0.3%, or about 0.1% to about 0.5% by weight, based on the total weight of the drinkable solution. In certain embodiments, the one or more flavoring agents can be present in an amount of about 0.05%, about 0.08%, about 0.1%, or about 0.2% by weight, based on the total weight of the drinkable solution. In particular embodiments, the one or more flavoring agents can be present in an amount of at least about 0.001%, at least about 0.05%, at least about 0.08%, at least about 0.1%, or at least about 0.2% by weight, based on the total weight of the drinkable solution.

### 4.2.9. Diluents

The drinkable solution can include one or more diluents. A person skilled in the art will appreciate a wide variety of diluents can be suitable for use with the present disclosure. In certain embodiments, the one or more diluents can include water.

The one or more diluents can be present in an amount of from about 75% to about 98%, about 80% to about 96%, or about 86% to about 96% by weight, based on the total weight of the drinkable solution. In certain embodiments, the one or more diluents can be present in an amount of about 75%, about 80%, about 85%, about 90%, about 96%, or about 98% by weight, based on the total weight of the drinkable solution. In particular embodiments, the one or more diluents can be present in an amount of at least about 70%, at least about 80%, at least about 90%, at least about 95%, or at least about 98% by weight, based on the total weight of the drinkable solution.

### 4.2.10. Formulations

Drinkable solutions of the present disclosure can include one or more electrolytes. In certain embodiments, the drinkable solutions can include one or more electrolytes, one or more trace minerals, one or more prebiotics, one or more sweeteners, one or more rehydration sugars, one or more preservatives, one or more acidulants, one or more flavoring agents, and one or more diluents. In certain embodiments, the drinkable solution can include from about 0.01% to about 5% of one or more electrolytes; from about 0.001% to about 1% by weight of one or more trace minerals; from about 0.01% to about 5% by weight of one or more prebiotics; from about 0.01% to about 5% of one or more sweeteners; from about 1% to about 8% by weight of one or more rehydration sugars; from 0.01% to about 3% by weight of one or more preservatives; from about 0.01% to about 2% by weight of one or more acidulants; from about 0.001% to about 0.5% by weight of one or more flavoring agents; and from about 70% to about 98% by weight of one or more diluents, based on the total weight of the drinkable solution. In certain embodiments, the one or more electrolytes can include sodium (as sodium chloride), chloride (as sodium chloride), and potassium (as tripotassium citrate); the one or more trace minerals can include zinc (as zinc gluconate); the one or more prebiotics can include gum acacia; the one or more sweeteners can include Rebaudioside M (RebM) and monk fruit (juice concentrate); the one or more rehydration sugars can include dextrose monohydrate; the one or more preservatives can include benzoic acid and potassium sorbate; the one or more acidulants can include citric acid; and the one or more diluents can include water.

In certain embodiments, drinkable solutions of the present disclosure can include one or more electrolytes, one or more trace minerals, one or more prebiotics, one or more sweeteners, one or more rehydration sugars, one or more acidulants, one or more flavoring agents, and one or more diluents. In certain embodiments, the drinkable solution can include from about 0.01% to about 5% of one or more electrolytes; from about 0.001% to about 1% by weight of one or more trace minerals; from about 0.01% to about 5% by weight of one or more prebiotics; from about 0.01% to about 5% of one or more sweeteners; from about 1% to about 8% by weight of one or more rehydration sugars; from about 0.01% to about 2% by weight of one or more acidulants; from about 0.001% to about 0.5% by weight of one or more flavoring agents; and from about 70% to about 98% by weight of one or more diluents, based on the total weight of the drinkable solution. In certain embodiments, the one or more electrolytes can include sodium (as sodium chloride), chloride (as sodium chloride), and potassium (as tripotassium citrate); the one or more trace minerals can include zinc (as zinc gluconate); the one or more prebiotics can include gum acacia; the one or more sweeteners can include Rebaudioside M (RebM) and monk fruit (juice concentrate); the one or more rehydration sugars can include dextrose monohydrate; the one or more acidulants can include citric acid; and the one or more diluents can include water.

### 4.3. Methods of Making Drinkable Solutions

In certain embodiments, a method of manufacturing a drinkable solution of the present disclosure is provided. A wide variety of processes can be used to provide the drinkable solutions of the present disclosure. In certain embodiments, the one or more diluents can be added to a suitable mixing vessel. The one or more rehydration sugars can be added to the one or more diluents to form a first solution. A pre-mix solution including the one or more electrolytes, one or more prebiotics, one or more trace minerals, optionally one or more preservatives, and one or more sweeteners can be prepared. The pre-mix solution can be added to the first solution and can be mixed (e.g., NLT 10 minutes) until dissolved to form a second solution. Alternatively, the one or more electrolytes, one or more prebiotics, one or more trace minerals, optionally one or more preservatives, and one or more sweeteners can be added to the first solution separately and mixed to form the second solution. The one or more flavoring agents and one or more sweeteners can be added to the second solution to form a third solution and mixed (e.g., NLT 10 minutes). The one or more acidulants can be added to the third solution and mixed (e.g., NLT 15 minutes) to form a fourth solution. The fourth solution can be transferred to a holding tank and then transferred into a pasteurizer (e.g., at about 185° F.) and filled into desired packaging, for example, individual pouches.

### 4.4. Methods of Using Drinkable Solutions

Drinkable solutions of the present disclosure can be used alone. Methods of using the drinkable solutions in the rehydration of a human in need thereof are provided. Such methods include administering the drinkable solutions of the present disclosure to the human.

### 4.5. Features of Drinkable Solutions

Drinkable solutions of the present disclosure can be ready to drink. In certain aspects, drinkable solutions of the present disclosure can be packaged into any suitable packaging, for example, individual pouches for single serve consumption.

### 5. EXAMPLES

The following Examples are intended to illustrate, but not to limit, the disclosed subject matter in any manner, shape, or form, either explicitly or implicitly.

### Example 1: Drinkable Rehydration Solutions

The present examples were prepared using the formulas in Tables 1-3.

TABLE 1
Drinkable Solution - Formulation 1

| | | Actual | | % |
|---|---|---|---|---|
| Ingredient | Function | mg/Serving | mg/Serving | W/W |
| Water | Diluent | 144227.8 | 144227.8 | 96.383 |
| Dextrose | Rehydration | 2214.3 | 2214.3 | 1.480 |
| Monohydrate | Sugar | | | |
| Sodium (as | Electrolyte | 176.0^{a} | 440.0 | 0.294 |
| Sodium Chloride) | | | | |
| Chloride (as | Electrolyte | 264.0^{a} | | |
| Sodium Chloride) | | | | |
| Potassium (as | Electrolyte | 99.0^{a} | 276.54 | 0.185 |
| Tripotassium | | | | |
| Citrate) | | | | |
| Zinc (as Zinc | Trace | 1.21^{a} | 9.84 | 0.007 |
| Gluconate) | Mineral | | | |
| Gum Acacia (Fiber) | Prebiotic | 992.41 | 1342.00 | 0.897 |
| Benzoic Acid | Preservative | 33.0 | 33.0 | 0.022 |
| Potassium Sorbate | Preservative | 40.0 | 40.0 | 0.027 |
| Citric Acid | Acidulant | 305.67 | 305.67 | 0.204 |
| Rebaudioside M | Sweetener | 12.5 | 13.16 | 0.009 |
| (Reb M) | | | | |
| Monk fruit Juice | Sweetener | 620.0 | 620.0 | 0.414 |
| Concentrate | | | | |
| Flavor | Flavor | 117.69 | 117.69 | 0.079 |
| TOTAL Serving | | | 149640.00 | 100.0 |
| Size | | | | |

^{a}Amount of the ion (sodium, potassium, chloride, zinc) present as part of the salt

### Processing Directions:

1. The water was added to a suitable mixing vessel.

2. The dextrose monohydrate was added and mixed until dissolved.

3. The sodium chloride, potassium citrate, zinc gluconate, gum acacia, benzoic acid, potassium sorbate, and Rebaudioside M (Reb M), were then added to a side phase, and mixed.

4. The side phase is added to the suitable mixing vessel and mixed NLT 10 minutes or until dissolved.

5. The Flavor and monk fruit juice concentrate are added to the solution and mixed NLT 10 minutes or until dissolved.

6. The citric acid is added to the solution and mixed NLT 15 minutes or until dissolved.

7. The final solution is transferred to a holding tank and then run through a pasteurizer at 185° F., and filled into individual pouches.

TABLE 2
Drinkable Solution - Formulation 2

| | | Actual | | % |
|---|---|---|---|---|
| Ingredient | Function | mg/Serving | mg/Serving | W/W |
| Water | Diluent | 144300.8 | 144300.8 | 96.431 |
| Dextrose | Rehydration | 2214.3 | 2214.3 | 1.480 |
| Monohydrate | Sugar | | | |
| Sodium (as | Electrolyte | 176.0^{a} | 440.0 | 0.294 |
| Sodium Chloride) | | | | |
| Chloride (as | Electrolyte | 264.0^{a} | | |
| Sodium Chloride) | | | | |
| Potassium (as | Electrolyte | 99.0^{a} | 276.54 | 0.185 |
| Tripotassium | | | | |
| Citrate) | | | | |
| Zinc (as Zinc | Trace | 1.21^{a} | 9.84 | 0.007 |
| Gluconate) | Mineral | | | |
| Gum Acacia (Fiber) | Prebiotic | 992.41 | 1342.00 | 0.897 |
| Citric Acid (QS pH | Acidulant | 305.67 | 305.67 | 0.204 |
| 3.7-4.0) | | | | |
| Rebaudioside M | Sweetener | 12.5 | 13.16 | 0.009 |
| (Reb M) (sugarcane) | | | | |
| Monk fruit Juice | Sweetener | 620.0 | 620.0 | 0.414 |
| Concentrate | | | | |
| Flavor | Flavor | 117.69 | 117.69 | 0.079 |
| TOTAL Serving | | | 149640.00 | 100.0 |
| Size | | | | |

^{a}Amount of the ion (sodium, potassium, chloride, zinc) present as part of the salt Serving Size: 149.64 mg/serving

### Processing Directions:

1. The water was added to a suitable mixing vessel.

2. The dextrose monohydrate was added and mixed until dissolved.

3. The sodium chloride, potassium citrate, zinc gluconate, gum acacia, and Rebaudioside M (Reb M), were then added to a side phase, and mixed.

4. The side phase is added to the suitable mixing vessel and mixed NLT 10 minutes or until dissolved.

5. The Flavor and monk fruit juice concentrate are added to the solution and mixed NLT 10 minutes or until dissolved.

6. The citric acid is added to the solution and mixed NLT 15 minutes or until dissolved.

7. The final solution is transferred to a holding tank and then run through a pasteurizer at 185° F., and filled into individual pouches.

TABLE 3
Drinkable Solution - Formulation 3

| | | Actual mg/ | mg/ | |
|---|---|---|---|---|
| Ingredient | Function | Serving | Serving | % W/W |
| Water | Diluent | 144231.8 | 144231.8 | 96.386 |
| Dextrose | Rehydration | 2214.3 | 2214.3 | 1.480 |
| Monohydrate | Sugar | | | |
| Sodium (as | Electrolyte | 176.0^{a} | 440.0 | 0.294 |
| Sodium | | | | |
| Chloride) | | | | |
| Chloride (as | Electrolyte | 264.0^{a} | | |
| Sodium | | | | |
| Chloride) | | | | |
| Potassium (as | Electrolyte | 99.0^{a} | 276.54 | 0.185 |
| Tripotassium | | | | |
| Citrate) | | | | |
| Zinc (as Zinc | Trace | 1.21^{a} | 9.84 | 0.007 |
| Gluconate) | Mineral | | | |
| Gum Acacia | Prebiotic | 992.41 | 1342.00 | 0.897 |
| (Fiber) | | | | |
| Citric Acid (QS | Acidulant | 232.1 | 232.1 | 0.156 |
| pH 3.7-4.0) | | | | |
| Rebaudioside | Sweetener | 12.5 | 12.5 | 0.008353% |
| M (Reb M) | | | | |
| (sugarcane) | | | | |
| Monk fruit | Sweetener | 620.0 | 620.0 | 0.414 |
| Juice | | | | |
| Concentrate | | | | |
| Flavor | Flavor | 260.0 | 260.0 | 0.174 |
| TOTAL | | | 149640.00 | 100.0 |
| Serving Size | | | | |

^{a}Amount of the ion (sodium, potassium, chloride, zinc) present as part of the salt Serving Size: 149.64 mg/serving

### Processing Directions:

1. The water was added to a suitable mixing vessel.

2. The dextrose monohydrate was added and mixed until dissolved.

3. The sodium chloride, potassium citrate, zinc gluconate, gum acacia, and Rebaudioside M (Reb M), were then added to a side phase, and mixed. The side phase is added to the suitable mixing vessel and mixed NLT 10 minutes or until dissolved.

4. The Flavor and monk fruit juice concentrate are added to the solution and mixed NLT 10 minutes or until dissolved.

5. The citric acid is added to the solution and mixed NLT 15 minutes or until dissolved.

6. The final solution is transferred to a holding tank and then run through a pasteurizer at 185° F., and filled into individual pouches.

### Example 2: Product Evaluation Testing (Formulation 2/Formulation 3)

Methodology. Formulation 2 and Formulation 3 were tested in a Central Location Test (CLT) in monadic product evaluations. The product trial of each formulation was one (1) pouch (5 fluid ounces). Each product was tested in two ways: (1) chilled and (2) at room temperature. A 15-minute interview (palate cleansing, wait 10 minutes, drink product, recall survey) was conducted. The one (1) 5-minute recall questionnaire was employed, and children entered their responses themselves on the online survey (older children) or the interviewer entered their responses for them (younger children). A subset of n=13 respondents were also video recorded drinking the product.

Key Data Thresholds. A product claim was considered supported if 65% or more give a top 2 box (T2B) agreement score. For 5-point scales: A bottom 2 box (B2B) score of 20% or more was considered a gross negative and indicative of potential risk. For 3-point scales: A bottom box (BB) score of 20% or more was considered a gross negative and indicative of potential risk.

Sample. Children ages 3-12 years old who used some type of electrolyte drink in the past 3 months (e.g., Gatorade®, Pedialyte®, Kinderlyte®, Liquid IV®, Powerade®, PRIME®, etc.)—25% incidence rate. Brand Users: 54% used Pedialyte® and/or Kinderlyte® at least once a month. Ages: 46% Ages 3-7 years old/54% Ages 8-12 years old. N=401 respondents as provided in Table 4 below.

TABLE 4

| | Chilled | Room Temperature | Total |
|---|---|---|---|
| | (N) | (N) | (N) |
| Formulation 2 (N) | 101 | 100 | 201 |
| Formulation 3 (N) | 100 | 100 | 200 |
| Total (N) | 201 | 200 | 401 |

Respondent Demographics. The demographics of the respondence are provided in Table 5.

TABLE 5

| Ethnicity of Child | |
|---|---|
| Hispanic | 44% |
| White/Caucasian | 37% |
| Black/African American | 18% |
| South Asian (Indian, Pakistani, etc.) | 4% |
| East Asian (Chinese, Japanese, etc.) | 2% |
| Hawaiian/Pacific Islander | 1% |

Brand Usage. Prior brand usage of electrolyte drinks are provided in Table 6.

TABLE 6

| Brand Usage | |
|---|---|
| Gatorade ® | 95% |
| Pedialyte ® | 63% |
| Powerade ® | 62% |
| PRIME ® | 29% |
| Liquid IV ® | 17% |
| Kinderlyte ® | 11% |
| NUUN ® | 1% |
| Other | 1% |

Overall Preferences Results. The results for overall preferences are shown below in Table 7.

TABLE 7

| | “Tastes | Top two box | Bottom two box |
|---|---|---|---|
| Sample | Good”¹ | Score | score |
| Overall (both | Yes | 66% Chilled | 14% Chilled |
| examples) | | 64% RT² | 19% RT² |
| Formulation 2 | Yes | 66% Chilled | 16% Chilled |
| | | 69% RT² | 19% RT² |
| Formulation 3 | Yes | 65% Chilled | 12% Chilled |
| | | 59% RT² | 19% RT² |

¹Based on top two boxes agreement with the statement “Tastes Good”. The chilled versions of both Formulation 2 and Formulation 3, as in scope for a “Kid Approved Taste” claim.
²Room temperature.

Product Attributes Results. The results for product attributes are shown in Table 8. The majority of respondents gave positive ratings for product attributes. Directional strengths were shown for chilled versions of Formulation 2 and Formulation 3.

TABLE 8
Product attribute statements: Formulation 2 and Formulation 3

| Attribute statement | % of respondents |
|---|---|
| Like the taste overall | 67 |
| Like the sweetness | 60 |
| Say the chilled temperature is just right | 76 |
| Like the aftertaste | 57 |
| Say amount of flavor is just right | 63 |
| Drank all or most of the product | 41 |

1. A drinkable solution, comprising:
one or more electrolytes;
one or more trace minerals;
one or more prebiotics; and
one or more rehydration sugars.

2. The drinkable solution of claim 1, wherein the one or more prebiotics comprises gum acacia.

3. The drinkable solution of claim 1, wherein the drinkable solution further comprises one or more preservatives.

4. The drinkable solution of claim 1, wherein the one or more rehydration sugars comprise dextrose monohydrate.

5. The drinkable solution of claim 1, wherein the one or more electrolytes comprises sodium, potassium, and chloride.

6. The drinkable solution of claim 1, wherein the drinkable solution further comprises one or more sweeteners.

7. The drinkable solution of claim 6, wherein the one or more sweeteners comprise Rebaudioside M (RebM), monk fruit (juice concentrate), or combinations thereof.

8. The drinkable solution of claim 1, wherein the one or more prebiotics are present in an amount of about 0.01% to about 5% by weight, based on the total weight of the drinkable solution.

9. The drinkable solution of claim 1, wherein the one or more electrolytes are present in an amount of at least about 0.01% by weight, based on the total weight of the drinkable solution.

10. A drinkable solution for the rehydration of a human, comprising:
one or more electrolytes comprising sodium, potassium, and chloride;
one or more sweeteners comprising Rebaudioside M (RebM);
one or more trace minerals; and
one or more prebiotics.

11. The drinkable solution of claim 10, wherein the one or more electrolytes are present in an amount of from about 0.01% to about 5% by weight, based on the total weight of the drinkable solution.

12. The drinkable solution of claim 10, wherein the one or more prebiotics comprises gum acacia.

13. The drinkable solution of claim 10, wherein the one or more trace minerals comprises zinc.

14. The drinkable solution of claim 10, wherein the one or more sweeteners further comprises monk fruit.

15. The drinkable solution of claim 10, wherein the drinkable solution further comprises one or more rehydration sugars, and wherein the one or more rehydration sugars comprise dextrose monohydrate.

16. The drinkable solution of claim 10, wherein the drinkable solution is substantially free of preservatives.

17. A method of rehydration of a human, the method comprising: administering the drinkable solution of claim 1 to the human.
